(19) United States
(12) Patent Application Publication
(10) Pub. No.: US 2011/0038616 A1
(43) Pub. Date: Feb. 17, 2011

(54) REPRODUCTION APPARATUS AND METHOD OF CONTROLLING A REPRODUCTION APPARATUS

(75) Inventors: Yoshio Kawakami, Osaka (JP); Tomokazu Kanamaru, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/671,959

(22) PCT Filed: Jun. 19, 2009
(86) PCT No.: PCT/JP2009/002801

§ 371 Date: Feb. 3, 2010

(30) Foreign Application Priority Data
Jun. 24, 2008 (JP) 2008-164077

(51) Int. Cl. H04N 5/93

(52) U.S. Cl. 386/353; 386/E05.003

(57) ABSTRACT

Provided is a playback device which enables, when playing back a recording medium having recorded thereon a digital stream and an application program, an execution result of the application to be shared among a plurality of devices. By having a Java application data writing unit 604 operable to output, to the outside of the playback device, data stored in an ADA 602, which is an area capable of being accessed by a Java application identified by an identifier held by a BD-ROM, the playback device generates data which can be input to another device. By having a Java application reading unit 605 operable to read out information which can be used during an execution of the application from a data export medium 606 being a removable medium to store the read out data in the ADA 602, the playback device can inherit information of another playback device, and play back the recording medium continuously.

### TECHNICAL FIELD

The present invention relates to a technology to play back a recording medium having recorded thereon a digital stream and an application program, and particularly a technology which enables a playback result of the recording medium to be shared among a plurality of devices.

### BACKGROUND ART

The BD-ROM specification allows not only a video and an audio but also a Java™ application to be included in a content. The Java application to be executed during playback of the content can control playback of a video and an audio, and can also store arbitrary data (hereinafter, application data) in a local storage in a device which is playing back the content.

The application data stored in this way is held in the local storage after playback of a BD-ROM is finished and a disc is ejected, and even after the device is turned off. Therefore, when a content is played back next time, by the application data stored in the local storage being read out and used by a Java application to be executed, in addition to data on the disc, a previous execution result can be inherited even after once the device is turned off.

The following technology is known as a technology to enable playback of a digital stream, which is video and audio data, to be shared among devices. By the technology (Patent Literature 1), (i) information specifying a digital stream having been stored in a recording medium and (ii) playback position information in the specified digital stream are shared among a plurality of devices.

### CITATION LIST

### Patent Literature

Patent Literature 1: Japanese Patent Application Publication No. 2005-203012

### SUMMARY OF INVENTION

### Technical Problem

In view of a use case where one user plays back a BD-ROM by using a plurality of playback devices (e.g. a BD player placed at home, an in-car BD player), it is desired that an execution result of an application is shared among a plurality of devices. However, in the conventional technology, application data is stored in a local storage in each device. For this reason, there is a problem that an execution result of a Java application cannot be shared among a plurality of devices in the use case where a BD-ROM is played back in the plurality of devices.

The present invention was conceived in view of the above problem, and aims to provide a playback device which enables an execution result of an application program to be shared among a plurality of devices when a recording medium having recorded thereon a digital stream and an application program is played back.

### Solution to Problem

In order to achieve the above-mentioned object, the present invention provides a playback device that plays back a digital stream having been stored in a read-only recording medium and executes an application program, the playback device comprising: an internal recording medium that has a recording area from/into which the application program is permitted to read/store information, the recording area being identified by an identifier held by the read-only recording medium, and an external output unit operable to output, to the outside of the playback device, information stored by executing the application program in the recording area from/into which the application program is permitted to read/store information.

Also, in order to achieve the above-mentioned object, the present invention provides a playback device that plays back a digital stream having been stored in a read-only recording medium and executes an application program, the playback device comprising: an internal recording medium that has a recording area from/into which the application program is permitted to read/store information, the recording area being identified by an identifier held by the read-only recording medium, and an external input unit operable to acquire, from the outside of the playback device, information which can be used when the application program is executed, and store the acquired information in the recording area from/into which the application program is permitted to read/store information.

### ADVANTAGEOUS EFFECTS OF INVENTION

With the above-mentioned structure, the playback device in the present invention can output a change which occurs with playback of a read-only recording medium to the outside by having an output unit for outputting, to the outside of the playback device, information stored by executing an application.

Also, the playback device can acquire the change which occurs with playback of a read-only recording medium in another device from the outside by having an acquisition unit for acquiring, from the outside of the playback device, information which can be used during an execution of an application.

Accordingly, since application data stored in a device can be used in another device, an execution result of an application program can be shared among a plurality of devices in terms of playback of a recording medium having recorded thereon a digital stream and an application program.

### BRIEF DESCRIPTION OF DRAWINGS

FIG. 1 shows a use case of a playback device in embodiment 1 of the present invention.

FIG. 2 shows a structure of a BD-ROM.

FIG. 3 shows a layer model of a playback control in embodiment 1 of the present invention.

FIG. 4 shows movies created by performing dynamic playback control in two kinds of modes in embodiment 1 of the present invention.

FIG. 5 shows an internal structure of a playback device 102.

FIG. 6 shows a mechanism to share application data among playback devices.

FIG. 7 shows a structure of a local storage 24.

FIG. 8 shows an example of an application data storage unit 602 configured in an ADA.

FIG. 9 shows an example of an application data storage unit 602 configured in a BUDA.

FIG. 10 shows an example of a data export medium 606 in embodiment 1.

FIG. 11 shows an example of a screen which is displayed when inquiring a content whose application data is to be output to the outside.

FIG. 12 shows an example of a screen which is displayed when requesting insertion of a removable medium used as the data export medium 606.

FIG. 13 is a flow chart showing steps of application data output processing.

FIG. 14 is a flow chart showing steps of application data input processing.

FIG. 15 shows a mechanism to share application data among playback devices in embodiment 2.

FIG. 16 shows an example of the data export medium 606 in embodiment 2.

FIG. 17 is a flow chart showing steps of application data output processing in embodiment 2.

FIG. 18 is a flow chart showing steps of application data input processing in embodiment 2.

FIG. 19 shows a use case of a playback device in embodiment 3.

FIG. 20 shows a mechanism to share content data among playback devices in embodiment 3.

FIG. 21 shows a display example of a TV 103 in embodiment 3 of the present invention.

FIG. 22 shows a display example of a TV 103 in embodiment 3 of the present invention.

FIG. 23 shows a display example of a TV 103 in embodiment 3 of the present invention.

FIG. 24 is a schematic diagram showing an example of a Java application storage unit 602 in embodiment 3 of the present invention.

### DESCRIPTION OF EMBODIMENTS

In the following, embodiments of the present invention are described with reference to the attached drawings.

### Embodiment 1

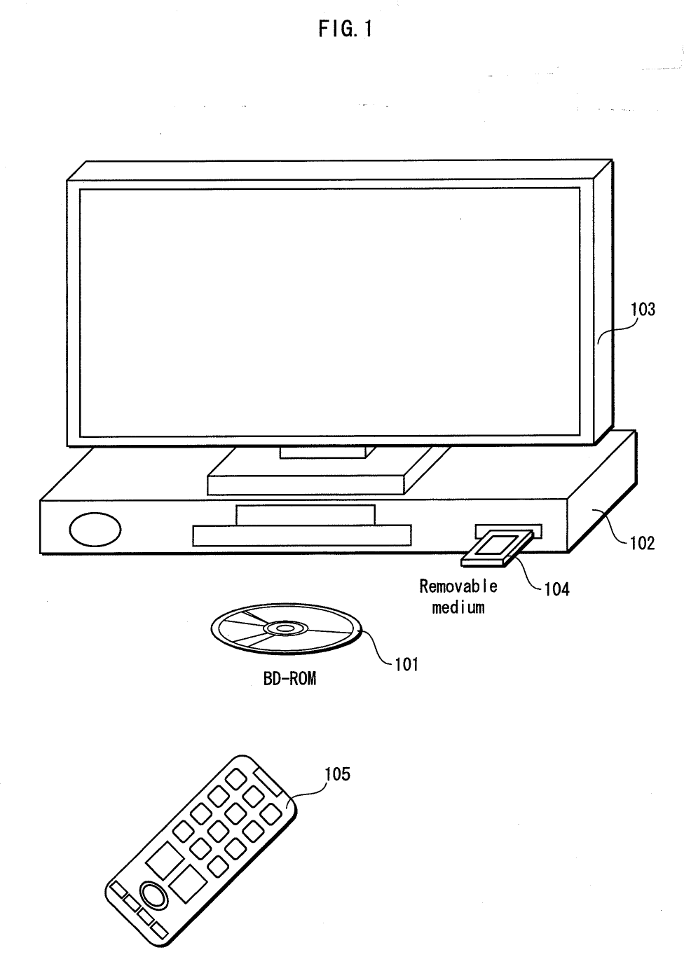

First, a use case of a playback device in the present invention is described as follows. FIG. 1 shows the use case of the playback device pertaining to the present invention. As shown in the drawing, a playback device 102 is used by a user along with a BD-ROM 101, a TV 103, a removable medium 104, and a remote control 105.

The BD-ROM 101 is a recording medium having recorded thereon a movie.

The playback device 102 constructs a home theater system with the TV 103 to play back the BD-ROM 101. Also, the playback device 102 has an insertion slot into which the removable medium 104 (e.g. an SD memory card, a memory stick, a Compact Flash™, smart media, a multimedia card, an attachable/detachable hard disc drive) is inserted.

The TV 103 provides a user with an interactive operational environment by displaying a playback image of a movie, a menu, and the like.

The remote control 105 comes with the playback device 102. It receives an operation to the playback device 102 from a user, and transmits an instruction signal according to the operation to the playback device 102.

The above is the description of the use case of the playback device pertaining to the present invention. The following describes a recording medium to be played back by the playback device pertaining to the present invention. In this example, the BD-ROM 101, which is an optical recording medium, is played back by the playback device pertaining to the present invention.

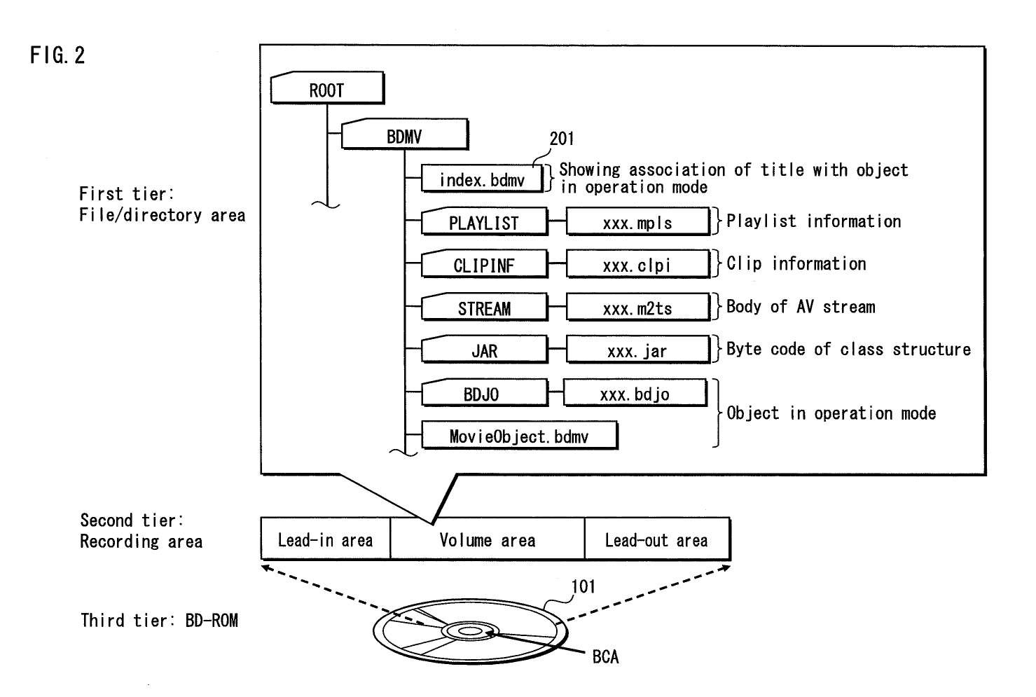

FIG. 2 shows a structure of the BD-ROM (hereinafter, also referred to as “BD”). In this embodiment, the BD-ROM is explained by taking an AV application for playing back an AV content like movie into consideration. However, the BD-ROM may, of course, be used as a recording medium for computer use like a CD-ROM and a DVD-ROM. Similar to the other optical discs (e.g. a DVD, a CD), the BD-ROM has a recording area which is formed in a spiral manner winding from an inner circumference toward an outer circumference of the BD-ROM, and has a logical address space which can store logical data between a lead-in area in the inner circumference and a lead-out area in the outer circumference. Also, within the lead-in area, it has a special area called BCA (Burst Cutting Area) which can be read out only by a drive. This area is often used, for example, for a copyright protection technology, because the area cannot be readout from an application.

In the logical address space, application data like image data has been stored. At the head of such data, file system information (volume) has been stored. The file system refers to, for example, UDF and ISO9660, and, in a manner similar to any conventional PC, logical data stored on the BD-ROM can be read via a directory/file structure, and file names and directory names up to 255 characters are readable.

In the directory/file structure on the BD disc in this embodiment, a BDMV directory is located immediately under a Root directory. The BDMV directory is a directory having stored therein data like an AV content and management information residing on the BD-ROM.

Five subdirectories called a PLAYLIST directory, a CLIPINF directory, a STREAM directory, aBDJO directory, and a JAR directory, respectively, are located under the BDMV directory. Also, two kinds of files called an index.bdmv and a MovieObject.bdmv, respectively, are located under the BDMV directory.

The STREAM directory is a directory having stored therein a file being, so to say, a body of a digital stream, and a file assigned an extension m2ts (xxx.m2ts [“xxx” is variable, the extension “m2ts” is fixed]) is located under the STREAM directory. A file assigned an extension mpls (xxx.mpls [“xxx” is variable, the extension “mpls” is fixed]) is located under the PLAYLIST directory. A file assigned an extension clpi (xxx.clpi [“xxx” is variable, the extension “clpi” is fixed]) is located under the CLIPINF directory. A file assigned an extension jar (xxx.jar [“xxx” is variable, the extension “jar” is fixed]) is located under the JAR directory. A file assigned an extension bdjo (xxx.bdjo [“xxx” is variable, the extension “bdjo” is fixed]) is located under the BDJO directory.

The file assigned the extension “m2ts” is a file for storing a digital AV stream in a MPEG-TS (Transport Stream) format and the digital AV stream is acquired by multiplexing at least one video stream, at least one audio stream, and at least one sub-video stream. The video stream indicates a moving image part of a movie, the audio stream indicates an audio part of a movie, and the sub-video stream indicates a subtitle part of a movie.

The file assigned the extension “clpi” is a file for storing Clip information in one to one correspondence with a digital AV stream. Since the Clip information is management information, it has pieces of information about an encoding format, a frame rate, a bit rate, a resolution and the like of the digital AV stream, and an EP_map showing a head position of a GOP.

The file assigned the extension “mpls” is a file for storing Playlist information. And a playback section of a stream (“In Time/Out Time”) is recorded thereon.

The file assigned the extension “jar” is a Java Archive file, and a Java application program for performing a dynamic scenario control using a Java virtual machine is described thereon. This file is required when playback of each title, which indicates a playback unit of a content on the BD-ROM, is desired to be controlled by the Java application.

The file assigned the extension “bdjo” is a file for storing a BD-J object. The BD-J object is information defining a title by associating an AV stream indicated by the Play List information with an application. The BD-J object shows an “application management table” and a Play List capable of being played back from the title. The application management table is a table for showing applications each having a life cycle bounded to this title by listing identifiers of the applications (application IDs) and Java Archive file IDs each belonging to a corresponding application. That is to say, one application is composed of one or more Java Archive files.

The index.bdmv (the file name is fixed as “index.bdmv”) is a file for storing management information about a whole BD-ROM. It stores information like an organization ID (32 bit), which is an identifier to identify a provider of a movie, and a disc ID (128 bit), which is an identifier allocated to each BD-ROM provided by the provider. By the index.bdmv being read out soon after a disc is inserted into a playback device, the disc is uniquely recognized by the playback device. Additionally, the index.bdmv includes a table in which a plurality of titles capable of being played back from the BD-ROM and the BD-J object defining each title is associated.

The MovieObject.bdmv (the file name is fixed) includes a scenario program having described thereon a scenario to dynamically change playback progression when playing back each title in a HDMV mode (described later).

Note that the above-mentioned file/directory structure is just an example, and the present invention can be realized by the other structure.

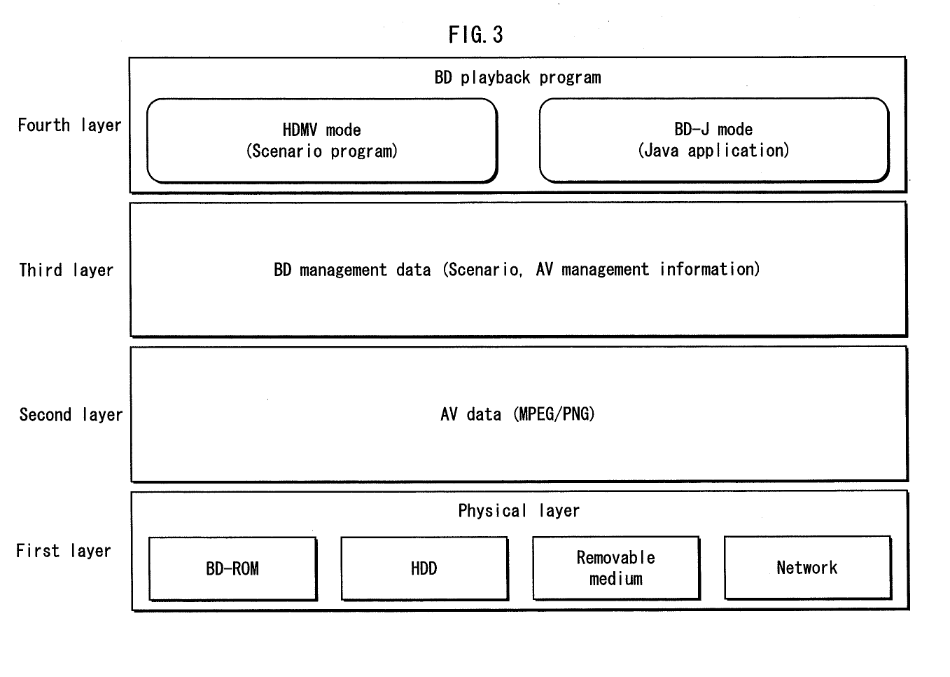

FIG. 3 shows a layer model of a playback control. In FIG. 3, a first layer is a physical layer. It performs control over provision of a body of a stream to be processed. As shown in the first layer, the stream to be processed is provided not only by a BD-ROM but also by any other recording medium and a communication medium (e.g. a local storage like an HDD (Hard disc drive) being a recording medium having preliminarily embedded in a playback device, a removable medium, and a network). The first layer performs control (disc access, card access, and network communication) over these local storage, removable medium, and network, which provide the stream.

A second layer is a layer of AV data. The second layer defines a decoding method to decode a stream provided in the first layer.

A third layer (BD management data) is a layer for defining a static scenario of a stream. The static scenario is playback path information and stream management information, which are preliminarily defined by a disc creator. And the third layer defines playback control based on these pieces of information.

A fourth layer (BD playback program) is a layer for realizing a dynamic scenario of a stream. The dynamic scenario refers to a program executing at least either of the playback procedure of an AV stream and the control procedure related to the playback. The playback control performed based on the dynamic scenario changes in response to a user operation made to the device and thus has a property like a program. There are two kinds of modes to perform dynamic playback control as described above. One of the two modes is a mode in which moving image data recorded on a BD-ROM is played back in a playback environment particular to AV equipment (HDMV mode). The other mode is a mode in which high value is added to the moving image data recorded on the BD-ROM (BD-J mode). In FIG. 3, both the HDMV mode and the BD-J mode are described on the fourth layer. The HDMV mode is a playback mode in a DVD-like playback environment, and a scenario program having described thereon a scenario to dynamically change playback progression operates in this mode. The BD-J mode is a playback mode mainly focusing the Java virtual machine, and a Java application performs playback control.

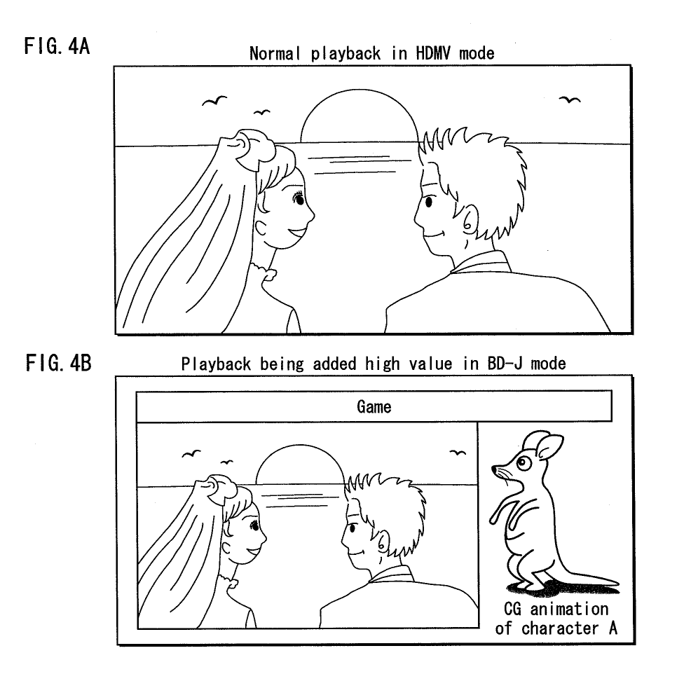

FIG. 4 shows movies created by performing dynamic playback control in the above-mentioned two kinds of modes. FIG. 4A shows a scene of a movie created by defining dynamic playback control in the HDMV mode. In the HDMV mode, since playback control can be described with a command similar to a command capable of being interpreted by a DVD playback device, it is possible to define playback control in a manner similar to DVD's such that the playback proceeding changes in response to a selection made on a menu.

FIG. 4B shows a scene of a movie created by defining dynamic playback control in the BD-J mode. In the BD-J mode, control process can be described by the Java language capable of being interpreted by the Java virtual machine. In the case where the playback control defines the behavior of computer graphics (CG) images, it is possible to define playback control in the BD-J mode with CG animation (a character A in the drawing) moving around next to the moving image playback screen. The above is the description of the BD-ROM 101.

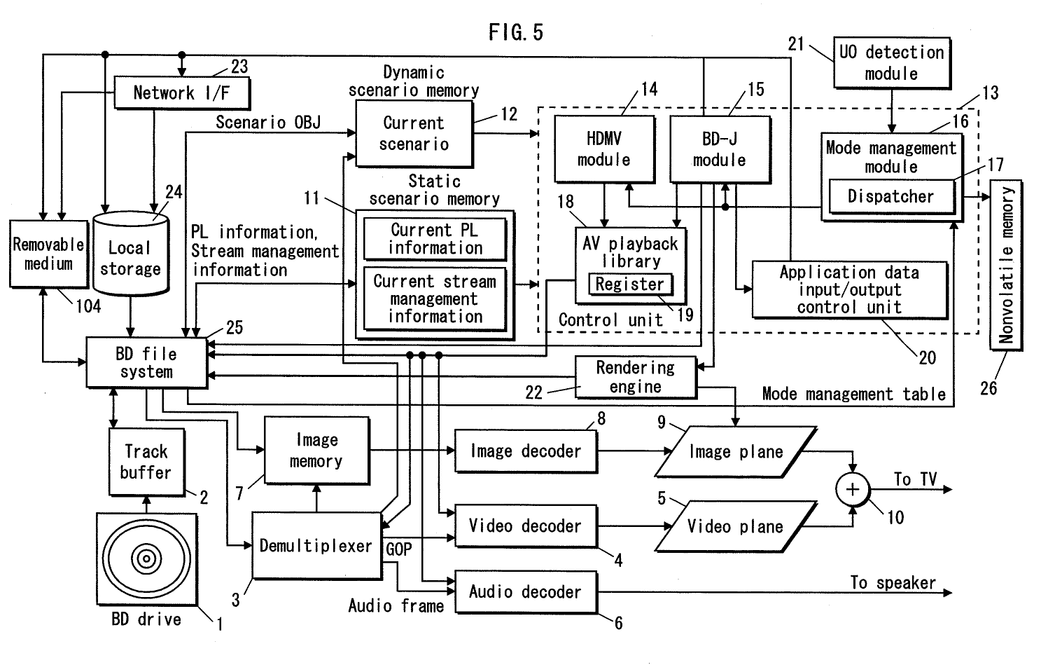

In the following, details about the playback device 102 in this embodiment are described. FIG. 5 is a block diagram roughly showing a functional structure of the playback device. As shown in FIG. 5, the playback device is composed of a BD-ROM drive 1, a track buffer 2, a demultiplexer 3, a video decoder 4, a video plane 5, an audio decoder 6, an image memory 7, an image decoder 8, an image plane 9, an composition unit 10, a static scenario memory 11, a dynamic scenario memory 12, a control unit 13, an HDMV module 14, a BD-J module 15, a mode management module 16, a dispatcher 17, an AV playback library 18, a register 19, an application data input/output control unit 20, a UO detection module 21, a rendering engine 22, a network interface 23, a local storage 24, a virtual file system 25, and a nonvolatile memory 26. In the drawing, a removable medium 104 attached to the playback device 102 is also described.

The BD-ROM drive 1 loads/ejects the BD-ROM, and implements an access to the BD-ROM. Note that the BD-ROM drive 1 may not only read data from the BD-ROM, but also read/write data from/to a readable/writable BD-RE, and use various kinds of recording media (e.g. a DVD and a CD).

The track buffer 2, which is a FIFO memory, stores an ACCESS UNIT read out from the BD-ROM on a first-in first-out basis.

The demultiplexer 3 demultiplexes a transport stream stored in the BD-ROM loaded on the BD-ROM drive 1, or the local storage 24 or the removable medium 104 to acquire a video frame and an audio frame configuring a GOP, and outputs the video frame to the video decoder 4 and outputs the audio frame to the audio decoder 6. A sub-video stream is stored in the image memory 7, and Navigation Button information is stored in the dynamic scenario memory 12. The demultiplexing performed by the demultiplexer 3 includes processing of converting TS packets into PES packets.

The video decoder 4 decodes the video frame output from the demultiplexer 3, and writes a picture in uncompressed format into the video plane 5.

The video plane 5 is a memory for storing the picture in uncompressed format.

The audio decoder 6 decodes the audio frame output from the demultiplexer 3, and outputs audio data in uncompressed format.

The image memory 7 is a buffer for storing a sub-video stream read out from the demultiplexer 3, PNG data in the Navigation Button information, or an image file read out from, via the virtual file system 25, a BD-ROM, the removable medium 104, or a local storage 24.

The image plane 9 is a memory having an area equivalent to one screen. Extracted sub-video stream, PNG data, and image file are allocated thereto.

The image decoder 8 extracts the sub-video stream, the PNG data, and the image file which are stored in the image memory 7, and write them in the image plane 9. By decoding the sub-video stream, various menus and a sub-video are displayed on a screen.

The composition unit 10 overlays an image extracted to the image plane 9 on picture data in uncompressed format stored in the video plane 5 to output a composite image. A screen shown in FIG. 4B (i.e. a screen in the drawing in which a picture of a kangaroo is moving around) is output by the composition unit 10 synthesizing an image on the image plane 9 and a picture on the video plane 5.

The static scenario memory 11 is a memory for storing a current PL and current stream management information. The current PL is a PL which is targeted for processing at the time, among a plurality of PLs stored in the BD-ROM, the local storage 24, or the removable medium 104. The current stream management information is stream management information which is targeted for processing at the time, among a plurality of stream management information pieces stored in the BD-ROM, the local storage 24, or the removable medium 104.

The dynamic scenario memory 12 is a memory for storing a current dynamic scenario which is to be processed by the HDMV module 14 and the BD-J module 15. The current dynamic scenario is a scenario which is targeted for processing at the time, among a plurality of scenarios stored in the BD-ROM, the local storage 24, or the removable medium 104.

The control unit 13 is a microcomputer system composed of ROM, on which a program controlling the playback device is recorded, RAM, and CPU. The program recorded on the ROM is read to the CPU, and the program and hardware sources work together to realize functions of the HDMV module 14, the BD-J module 15, the mode management module 16, the dispatcher 17, the AV playback library 18, the application data input/output control unit 20.

The HDMV module 14 is a DVD virtual player acting as the execution entity in the HDMV mode. It executes a current scenario program read out to the dynamic scenario memory 12.

The BD-J module 15 is a Java platform, and composed of a Java virtual machine, a configuration, and a profile. The BD-J module 15 generates a current Java object from a Java class file read out to the dynamic scenario memory 12 to execute it. The Java virtual machine converts the Java object written in a Java language to a native code of a CPU in the playback device, and causes the CPU to execute it.

The UO detection module 21 detects user operation made through a remote control and a front panel of a playback device, and outputs information showing the user operation (hereinafter, referred to as UO (User Operation)) to the mode management module 16.

The mode management module 16 holds a mode management table read out from the BD-ROM, the local storage 24, or the removable medium 104, and carries out a mode management and a branch control. The mode management carried out by the mode management module 16 indicates a module allocation for allocating the execution of a dynamic scenario to one of the HDMV module 14 and the BD-J module 15.

The dispatcher 17 selects a UO which is appropriate to a current mode of a playback device, from among UOs, and passes the selected UO to a module which performs the mode. For example, when receiving a UO such as “upward”, “downward”, “leftward”, “rightward” or “activate” during an execution of the HDMV mode, the dispatcher 17 outputs the received UOs to a module which performs the HDMV mode.

The rendering engine 22 is provided with infrastructure software like Java 2D and OPEN-GL. It renders computer graphics in accordance with instructions given from the BD-J module 15, and outputs the rendered computer graphics to the image plane 9.

The AV playback library 18 performs an AV playback function and a playlist playback function in response to a function call from the HDMV module 14 or the BD-J module 15. The AV playback function is a group of functions having been taken over from a DVD player and a CD player. The AV playback function includes processing like “play”, “stop”, “pause on”, “pause off”, “still image function off”, “fast forward at the speed specified with immediate value”, “fast rewind at the speed specified with immediate value”, “audio change”, “sub-video change”, and “angle change”. The playlist playback function is “play” and “stop” among these AV playback functions performed in accordance with playlist information.

The AV playback library 18 includes the register 19. The register 19 has an area in which a playback state of a playlist and arbitrary information used by a content can be stored. The playback state of the playlist shows a state, for example, which AV data among various pieces of AV data information described in the play list is used, and to which position (time) in the play list, the AV data is played back. When the playback state of a play list is changed, the AV playback library 18 stores the changed state in the register 19. Also, by being instructed from a content which is executed by the HDMV module 14 or the BD-J module 15, it is possible to store a value specified by the content, and pass the stored value to the content.

The application data input/output control unit 20 controls the following two processing: One is application data external output processing in which application data stored in the local storage 24 is copied to the removable medium 104. The other is application data external input processing in which application data stored in the removable medium 104 is retrieved in the local storage 24.

The network interface 23 is used for communicating with the outside of the playback device. Via the network interface 23, the playback device 102 can access a server which is accessible through the internet, access a server which is attached to a local network, communicate with the other playback device and a peripheral device which are directly or indirectly connected to the playback device, and so on. Also, it is possible to monitor a connection status from the outside to the network interface 23, and any change in the connection status can be notified.

Note that the network interface 23 can be realized by using a publicly known technology like the Ethernet™ (IEEE 802.3), IEEE 1394, the USB (Universal Serial Bus), the HDMI (High-Definition Multimedia Interface), PLC (Power Line Communications).

For example, the network interface 23 is used to download a BD-ROM additional content publicized on the internet, and enables playback of a content using a network function by performing data communication with a server on the internet specified by the content. The BD-ROM additional content is, for example, an additional sub-audio, a subtitle, a special image, an application, which are not contained in an original BD-ROM. The network interface 23 is controllable by the BD-J module 15, and thereby an additional content publicized on the internet can be downloaded into the local storage 24 or the removable medium 104. And it is possible to communicate (i.e. reading/writing of data) with a hard disc drive which is connected via the network interface 23.

The local storage 24 and the removable medium 104 are used for storing the downloaded additional content, data used by an application, and the like. A storage area of the additional content varies depending on a BD-ROM, and also an area which is used by an application to store data varies depending on the application. Also, merge management information is stored in the local storage 24 and the removable medium 104. In the merge management information, a merge rule which defines how to merge the downloaded additional content with data on the BD-ROM is described.

The virtual file system 25 constructs a virtual BD-ROM (a virtual package), in which an additional content stored in the local storage 24 or the removable medium 104 and a content on a BD-ROM are merged based on the merge management information which is downloaded into the local storage 24 or the removable medium 104 along with the additional content. The virtual package and an original BD-ROM can be referred to without being distinguished from each other by the HDMV module 14 and the BD-J module 15. When playing back the virtual package, the playback device performs playback control by using both data on the BD-ROM and data on the local storage 24 or the removable medium 104.

The above is components of the playback device.

The nonvolatile memory 26 is a readable/writable recording medium, and can hold recorded data without electronic supply. It is, for example, a flush memory and a FeRAM. Also, the removable medium 104, the local storage 24, and a recording medium which can be written in the BD drive 1 can be used as the nonvolatile memory 26. Further also, a medium which is accessible via the network interface 23 can be used as the nonvolatile memory 26 as long as it can hold the recorded data independent of the electronic supply status of the playback device.

Note that functional configurations described above show an example of a BD-ROM playback device. The present invention can be realized by the other functional configurations as long as the following operation can be realized by the functional configurations.

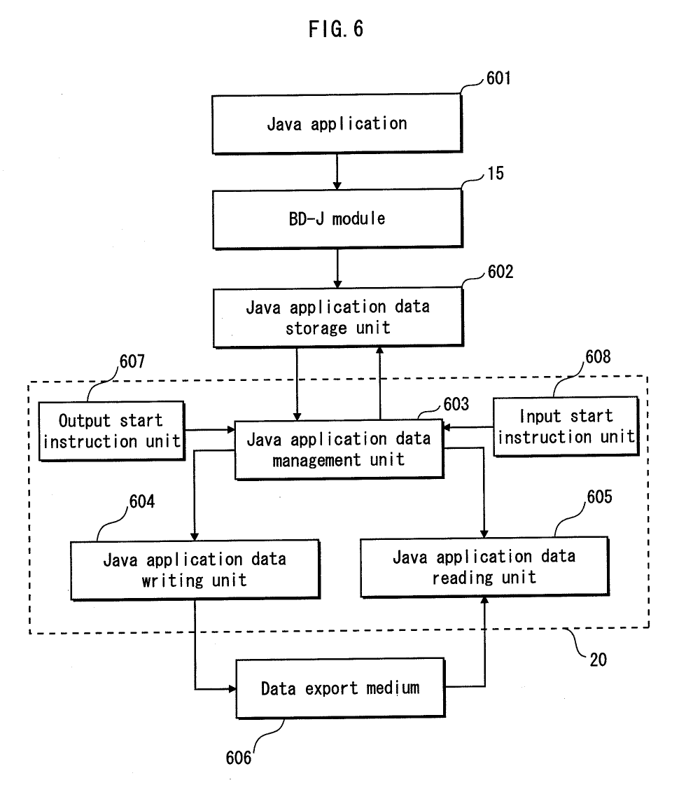

In this embodiment, the application data input/output control unit 20 is adopted as a mechanism to share content data stored in a device among playback devices. Details thereof are described with use of FIG. 6. Note that, to the same components as those in FIG. 5, same numbers are assigned, and explanations thereof are omitted.

A Java application 601 executed by the BD-J module 15 reads out/writes data from/to the Java application data storage unit 602 via the BD-J module 15.

The Java application data is a general term of data which is read out/written from/to the application data storage unit 602 by the Java application 601 via the BD-J module 15. It is, for example, a value of an internal variable used by the Java application during an execution, and history information which is generated when any control is performed by user operation. When the Java application 601 bookmarks a certain playback position by being instructed by user operation, the user-specified bookmarked position is used as Java application data.

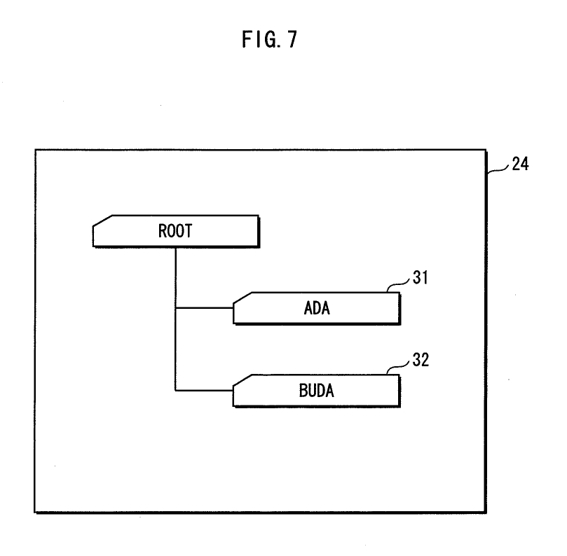

The Java application data storage unit 602 is a recording area from/to which data is read/written by the Java application 601 via the BD-J module 15. Specifically, it is the local storage 24, the removable medium 104, a disc inserted into the BD drive 1, and the like. Moreover, a recording area in an external recording device which is accessible via the network interface 23 can be used as the Java application data storage unit 602. For example, it is possible that the Java application 601 transmits data desired to be written to a server connected to the internet, and the server stores received data in a recording medium (e.g. a hard disc drive). Conversely, it is also possible that the Java application 601 receives data desired to be read from the server connected to the internet. Note that the Java application data storage unit 602 does not have to be one physical recording medium, and it may be a complex of a plurality of physical or logical recording area. For example, it may be composed of a part of the local storage 24 and the removable medium 104. In this embodiment, a recording area in the local storage 24 is used as the Java application data storage unit 602. The recording area in the local storage 24 includes an ADA directory 31 and a BUDA directory 32 as shown in FIG. 7.

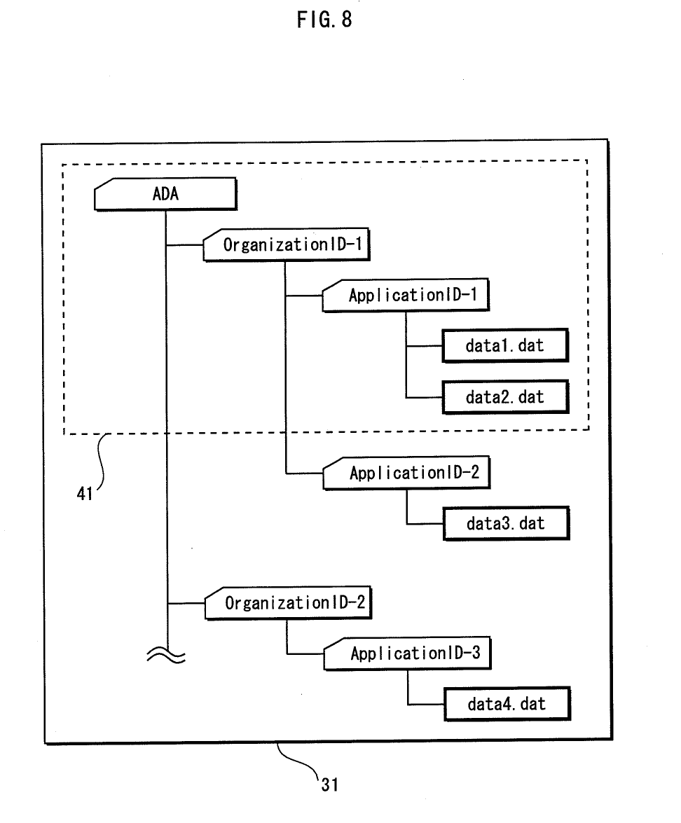

FIG. 8 shows an example the ADA directory 31 which is included in the Java application data storage unit 602 in this embodiment. The ADA directory 31 is a recording area from/to which data is allowed to be read/written by a Java application authenticated during an execution. As shown in FIG. 8, subdirectories named Organization ID are located under the ADA directory, and subdirectories named Application ID are located under the Organization ID subdirectories. The Organization ID is described on a BD-J object on a BD-ROM, and is an identifier with 32 bit for identifying an organization which created an application. On the other hand, the Application ID is described on the BD-J object as well, and is an identifier with 16 bit for identifying an application. In the ADA area, each Java application is allowed to read/write application data only from/to under corresponding directories named the Organization ID and the Application ID. Such access restriction is controlled by the BD-J module 15.

In an example of FIG. 8, the ADA directory 31 includes “data1.dat”, “data2.dat”, “data3.dat”, and “data4.dat”, which are pieces of data stored by the Java application. The “data1.dat” and the “data2.dat” are pieces of data stored by a Java application having identifiers named “Organization ID-1” and “Application ID-1”. The “data3.dat” is data stored by a Java application having identifiers named “Organization ID-1” and “Application ID-2”. The “data4.dat” is data stored by a Java application having identifiers named “Organization ID-2” and “Application ID-3”.

Note that the “Organization ID-1”, “Organization ID-2”, “Application ID-1”, “Application ID-2” and “Application ID-3” are paired, respectively, as a pair of identifiers for identifying a Java application, and the present invention can be realized by a pair determined in any kind of selection methods.

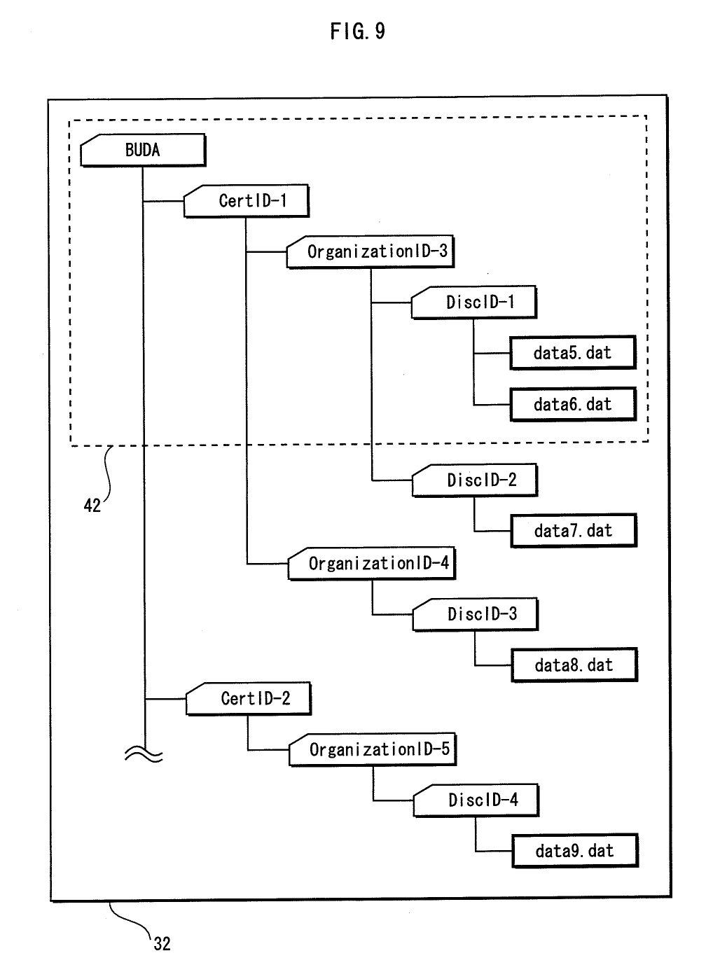

FIG. 9 shows an example the BUDA directory 32 which is included in the Java application data storage unit 602 in this embodiment. The BUDA directory 32 is a recording area in which an additional content used when the virtual file system 25 creates a virtual package, and data used by a Java application are stored. In the drawing, only pieces of application data stored in the BUDA are described. As shown in the drawing, subdirectories named Cert ID are located under the BUDA directory, subdirectories named Organization ID are located under the Cert ID subdirectories, and subdirectories named Disc ID are located under the Organization ID subdirectories.

The Cert ID is an identifier led out from a disc root certificate (app.discroot.cert) on a BD-ROM. And a SHA-1 digest value of the disc root certificate is used as the ID. In a BUDA area in such directory structure, each Java application reads out/writes application data from/to under directories named the Cert ID, the Organization ID, and Disc ID in each BD-ROM disc so that a Java application relating to each piece of application data stored in the BUDA area can be easily figured out.

In an example of FIG. 9, the BUDA directory 32 includes “data5.dat”, “data6.dat”, “data7.dat”, “data8.dat” and “data9.dat”, which are pieces of data stored by the Java application. The “data5.dat” and the “data6.dat” are pieces of data to be used by a content having identifiers named “Cert ID-1”, “Organization ID-3” and “Disc ID-1”. The “data7.dat” is data to be used by a content having identifiers named “Cert ID-1”, “Organization ID-3” and “Disc ID-2”. The “data8.dat” is data to be used by a content having identifiers named “Cert ID-1”, “Organization ID-4” and “Disc ID-3”. The “data9.dat” is data to be used by a content having identifiers named “Cert ID-2”, “Organization ID-5” and “Disc ID-4”.

Note that the“Cert ID-1”, “Cert ID-2”, “Organization ID-3”, “Organization ID-4”, “Organization ID-5”, “Disc ID-1”, “Disc ID-2”, “Disc ID-3”, and “Disc ID-4” are paired, respectively, as a pair of identifiers for identifying a content, and the present invention can be realized by a pair determined in any kind of selection methods.

Also, as shown in FIG. 8 and FIG. 9, although the Java application data storage unit 602 can be configured in various file structures, the present invention can be realized in any of the file structures.

The Java application data management unit 603 in FIG. 6 transmits Java application data stored in the Java application data storage unit 602 to a Java application data writing unit 604. Also, it acquires Java application data from a Java application reading unit 605, and writes the acquired data to the Java application data storage unit 602.

The Java application data writing unit 604 stores the Java application data transmitted from the Java application data management unit 603 to a data export medium 606.

The Java application data reading unit 605 reads out the Java application data specified by the Java application data management unit 603 from the data export medium 606, and transmits the read out data to the Java application management unit 603.

Note that the Java application data management unit 603 is described to acquire the Java application data from the Java application data reading unit 605, however, there is no need to acquire all the Java application data read out by the Java application reading unit 605. It is possible to acquire a part of the data, and acquire only management information of the Java application data. The management information of the Java application data includes a name, size, update date and time and the like of a file/directory configuring the Java application data. In the present invention, the management information of the Java application data is also considered as a part of the Java application data.

The data export medium 606 is a recording medium on which the Java application data can be recorded. In this embodiment, the removable medium 104 is used as the data export medium 606.

An output start instruction unit 607 transmits a Java application data output instruction to the Java application data management unit 603. In this embodiment, the Java application data output instruction is output in response to detection of a UO showing pressing of an “output button” mounted on the playback device 102 and the remote control 105.

An input start instruction unit 608 transmits a Java application data input instruction to the Java application data management unit 603. In this embodiment, the Java application data input instruction is output in response to detection of a UO showing pressing of an “input button” mounted on the playback device 102 and the remote control 105.

Upon receiving the Java application data output instruction from the output start instruction unit 607, the Java application data management unit 603 reads a part or all of the Java application data stored in the Java application data storage unit 602, and transmits the read Java application data to the Java application writing unit 604.

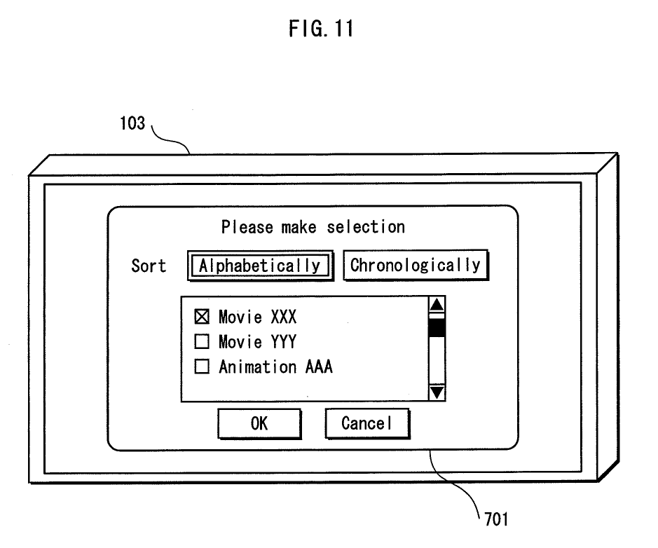

In the case where a part of the Java application data stored in the Java application data storage unit 602 is read here, any part of the Java application data can be selected in any way. For example, FIG. 11 shows an example of a screen which is displayed when inquiring of a user for a Java application data corresponding to each content which is to be output to the data export medium 606. In FIG. 11, a selection screen 701 is displayed on the TV 103 to prompt a user to make a selection using the remote control 105 and so on. Such function can be realized, for example, as shown in FIG. 9, by including information for identifying a content in the Java application data storage unit 602.

When the user selects a content name using a screen display in FIG. 11, the Java application data management unit 603 reads out Java application data used by a Java application corresponding to the selected content name from the Java application data storage unit 602, and transmits the read out data to the Java application data writing unit 604. Here, the number of content to be selected may be determined arbitrarily. Also, when the user decides to stop processing, the processing can be stopped by selecting “cancel”. In this example, although a method to make a selection in terms of a content is shown, the other selection method may be adopted. Also, Java application data relating to a content which has been played back most recently can be selected by a default, and a user can make a selection by inserting, into the playback device 102, a BD-ROM disc having recorded thereon a content the user desires to select.

Further also, the Java application data management unit 603 can read out only the Java application data corresponding to a content which has been played back most recently to transmit to the Java application data writing unit 604.

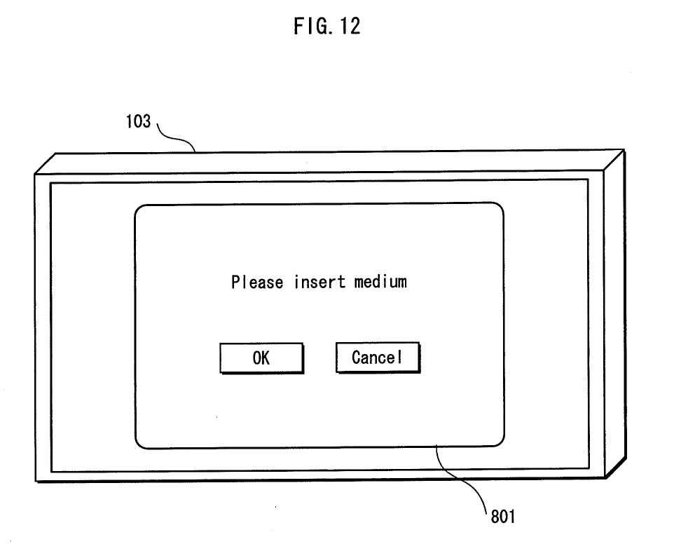

Upon receiving the Java application data transmitted from the Java application data management unit 603, the Java application data writing unit 604 stores the Java application data to the data export medium 606. Here, when the data export medium 606 to which the Java application data writing unit 604 can write the data does not exist, processing may be stopped. And when the processing is stopped, the playback device may show a user that the processing is stopped. And also, the playback device may request a user to insert a medium to allow the data export medium 606 to be used. FIG. 12 shows a display example of the TV 103 when requesting a user to insert a medium to allow the data export medium 606 to be used. A message 801 is displayed to prompt a user to insert a medium as the data export medium 606. When the user completes preparation of the data export medium 606, it becomes possible that the Java application data writing unit 604 stores data in the data export medium 606.

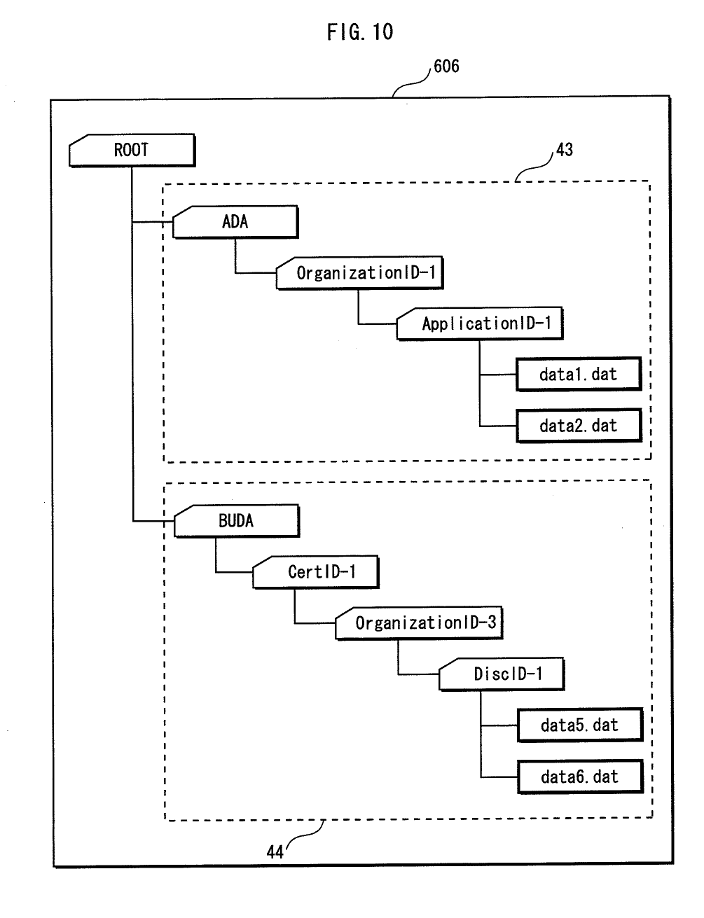

FIG. 10 is a schematic diagram showing an example of a file structure when application data read out from the Java application data storage unit 602 is stored in the data export medium 606. In this example, a group of files 43 and the group of files 44 are stored in the data export medium 606 as Java application data. These groups of data are created by copying (i) a group of files 41, which is a group of data stored by the Java application having identifiers named “Organization ID-1” and “Application ID-1” from among data stored in the ADA shown in FIG. 8, and (ii) a group of files 42, which is a group of data used by the content having identifiers named “Cert ID-1”, “Organization ID-3” and “Disc ID-1” from among data stored in the BUDA shown in FIG. 9, respectively.

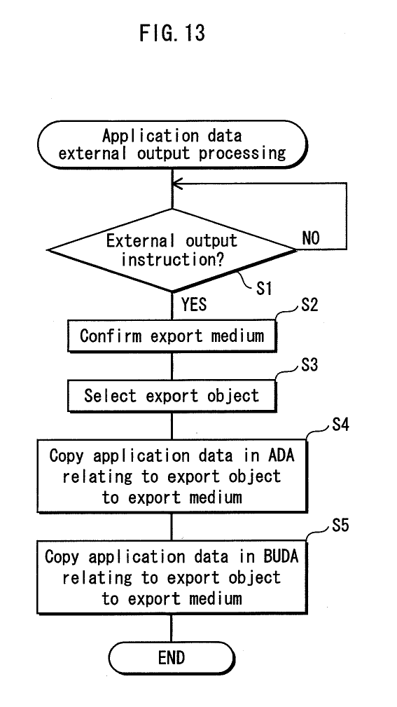

The following describes steps of application data external output processing, in which the Java application data is output to the data export medium, with use of FIG. 13.

The application data external output processing in this embodiment is started by the Java application data management unit 603 receiving a Java application data output instruction from the output start instruction unit 607 (step S1: Yes).

Upon receiving the output instruction, the Java application data management unit 603 instructs the rendering engine 22 to render a screen inquiring an object to be exported shown in FIG. 11, and receives selection of the object to be exported from a user (step S2). Next, it checks whether the removable medium 104 being an export medium is inserted or not. If the removable medium 104 is not inserted, it instructs the rendering engine 22 to render a screen requesting insertion of the removable medium shown in FIG. 12, and waits until a medium is inserted (step S3).

Then, the Java application data management unit 603 reads out application data corresponding to an identifier of a Java application to be exported, which is selected in the step S2, from the ADA area and the BUDA area, and instructs the Java application writing unit 604 to write the read out data to the removable medium 104. In response to this, the Java application data writing unit 604 writes the application data, which has the same directory structure as that in the ADA area and the BUDA area, to the removable medium 104 (step S4 and step S5). The above is the steps of the application data external output processing.

The following describes processing in which the Java application data is read out from the data export medium 606, with use of FIG. 6.

Upon receiving a Java application data input instruction from an input start instruction unit 608, the Java application data management unit 603 instructs the Java application data reading unit 605 to read out Java application data.

Upon receiving a Java application data reading instruction from the Java application data management unit 603, the Java application data reading unit 605 reads out the Java application data from the removable medium 104 being the data export medium 606, and transmits the read out data to the Java application management unit 603.

Upon receiving the Java application data from the Java application data reading unit 605, the Java application data management unit 603 stores the received Java application data in the Java application storage unit 602.

Note that the Java application data management unit 603 does not need to read out, via the Java application reading unit 605, all the Java application data stored in the data export medium 606 to store the read out data in the Java application data storage unit 602. It is possible to store a part of the Java application data stored in the data export medium 606 in the Java application data storage unit 602.

For example, the Java application data management unit 603 may be configured such that only a Java application data which will be used by a content to be played back from now is stored in the Java application data storage unit 602, and a Java application data which is different from that has been stored in the Java application data storage unit 602 is stored in the Java application data storage unit 602. Also, when information for identifying a BD-ROM disc corresponding to a Java application data (hereinafter, referred to as a BD-ROM disc identifier) is included in the data export medium 606, the Java application data management unit may be configured such that (i) a BD-ROM disc identifier included in the data export medium 606 and (ii) a BD-ROM disc identifier included in a BD-ROM disc inserted in the BD-ROM drive 1 in the playback device 102 are compared, and the Java application data included in the data export medium 606 is stored in the Java application data storage unit 602 only when (i) and (ii) correspond. This enables a restriction that a Java application data cannot be shared by different BD-ROM to be imposed. Therefore, unintended use of the Java application data can be prevented.

And, regardless of whether or not the BD-ROM disc identifier corresponding to the Java application data is included in the data export medium 606, the same Java application data can be shared among a plurality of users by configuring the Java application data management unit 603 so as to store the Java application data included in the data export medium 606 in the Java application data storage unit 602. Switching of such operation may be preliminarily determined at the time of storing the data in the data export medium 606 or reading the data, or may be selected by a user as needed.

Note that information which is generated based on a BCA, information calculated from a part or all of the data included in the BD-ROM disc, and the like can be used as the BD-ROM disc identifier. Also, password information set by a user, device specific information hold by the playback device 102 can be included in the BD-ROM disc identifier.

Note that the data stored in the data export medium 606 and data on an input/output pathway between the data export medium 606 and the playback device 102 may be described in a form different from a form in which the data stored in the Java application data storage unit 602 is described. For example, these pieces of data may be encrypted by a publicly known encryption technology to prevent them from being abused or tampered.

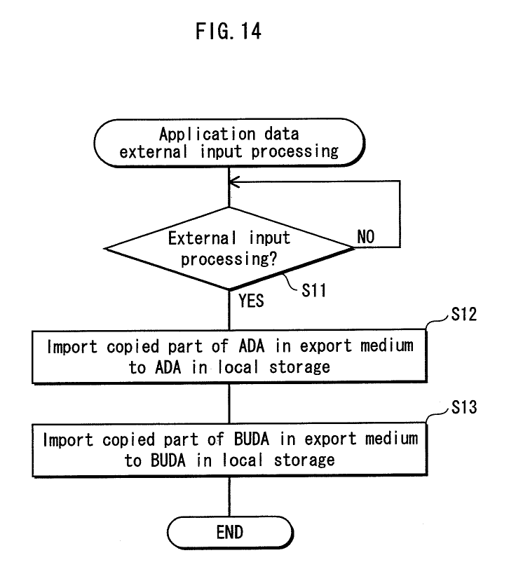

The following describes steps of application data external input processing, in which the Java application data included in the data export medium is stored in the Java application data storage unit 602 in the playback device, with use of FIG. 14.

The application data external input processing in this embodiment is started by the Java application data management unit 603 receiving a Java application data input instruction from the input start instruction unit 608 (step S11: Yes).

Upon receiving the input instruction, the Java application data management unit 603 instructs the Java application data reading unit 605 to read out the application data stored in a removable medium being the data export medium 606, and stores the read out application data in an ADA area and BUDA area in the local storage 24 configuring the Java application data storage unit 602 (step S12 and step S13). At this time, the Java application data management unit 603 stores the read out Java application data in the ADA area and the BUDA area in a directory structure same as that in the removable medium. The above is the steps of the application data external input processing.

Note that, when Java application data is stored in the data export medium 606 in a playback device, the Java application data stored in the data export medium 606 does not need to be used by a different playback device. For example, it may be read out by the original playback device in which the Java application data has been stored in the data export medium 606. When data stored in the Java application data storage unit 602 in the original playback device has not been changed, data stored in the Java application data storage unit 602 and data stored in the data export medium 606 may be the same one. However, when the data stored in the Java application data storage unit 602 in the original playback device has been changed, the present invention can be used as a backup of the Java application data, because the data stored in the data export medium 606 is the data stored in the Java application data storage unit 602 before changed.

As described above, in this embodiment, each Java application data storage unit 602 in a plurality of playback devices can store partially or completely same data. For example, after a Java application included in a content played back by a playback device stores any data (e.g. a game score), the data is stored in a local storage in another playback device via the data export medium 606. This enables, when the same content is played back by the other device, the Java application included in the content to acquire the same data even though the content is played back by the other playback device, and enables continuation of a playback state.

Note that, when considering a modified example of this embodiment, the data export medium 606 shown in FIG. 6 is a recording medium which can record Java application data, and characterized by being capable of being simultaneously or exclusively used by two or more playback devices. For example, the removable medium 104, which is an attachable/detachable recording medium, and a recording medium which can be used by the BD-ROM drive 1 can be used as the data export medium 606. Also, the data export medium 606 does not have to be physically connected to the playback device 102 as long as it is used by the Java application data writing unit 604 and the Java application data reading unit 605. For example, when the Java application data writing unit 604 and the Java application data reading unit 605 can use a server which exists the outside of the playback device 102 via the network interface 23, the data export medium 606 may be a hard disc drive connected to the server.

Also, the output start instruction unit 607 may transmit the Java application data output instruction at an arbitrary timing. And the Java application data output instruction may be transmitted by a user performing operation in accordance with a menu displayed on the TV 103. Also, the Java application data output instruction may be transmitted in the wake of connection of the data export medium 606. And, the Java application data output instruction may be transmitted at a timing when the playback device 102 is stopped, playback is stopped, or a medium is ejected. In contrast, the Java application data output instruction may be transmitted at any time during the playback of a content, or at a timing when Java application data is changed during an execution of the Java application. And, the Java application data output instruction may be transmitted at a timing being a combination of the above mentioned examples.

The output start instruction unit 607 may include a condition regarding whether a content is being played back in conditions for transmitting the Java application data output instruction in synchronization with the mode management module 16.

Further also, during playback of a content, a timing at which the Java application data output instruction is transmitted may be changed depending on whether data stored in the Java application data storage unit 602 is data written by the Java application data management unit 603 or not. For example, when the data stored in the Java application data storage unit 602 is the data written by the Java application data management unit 603, the Java application data output instruction may be necessarily transmitted at a timing when playback of a content is stopped, it may be transmitted after asking a user, and it may be frequently transmitted even during playback of a content.

Additionally, the input start instruction unit 608 may transmit the Java application data input instruction at an arbitrary timing. Although the Java application data input instruction may be transmitted at an arbitrary timing, processing which is accompanied with a change in the Java application data storage unit 602 capable of being used by a Java application should not be performed during an execution of the Java application. The Java application data input instruction may be transmitted by a user pressing a button which is mounted on the playback device 102 or the remote control 105. And the Java application data input instruction may be transmitted by a user performing operation in accordance with a menu displayed on the TV 103. Also, the Java application data input instruction may be transmitted in the wake of connection of the data export medium 606. And, the Java application data input instruction may be transmitted at a timing when the playback device 102 is started up, playback is started, or a BD-ROM is inserted. The Java application data input instruction may be transmitted depending on data stored in the BD-ROM. For, example, when Java application data corresponding to an inserted BD-ROM is included in the data export medium, the Java application data input instruction may be transmitted. And, the Java application data output instruction may be transmitted at a timing being a combination of the above mentioned examples. The input start instruction unit 608 may include a condition regarding whether a content is being played back in conditions for transmitting the Java application data input instruction in synchronization with the mode management module 16.

### Embodiment 2

In embodiment 1, the Java application data is described to be a general term of data which is read/written from/to the application data storage unit 602 by the Java application 601 shown in FIG. 6 via the BD-J module 15. In this embodiment, data stored in the register 19 shown in FIG. 5 is included in the Java application data.

Note that, to the same components as those in embodiment 1, the same numbers are assigned, and description thereof is omitted.

The data stored in the register 19 is data which is read out or written by the Java application 601 via the BD-J module 15. Accordingly, in embodiment 1, the data stored in the register 19 can be included in the Java application data. However, in this embodiment, a case where the Java application management unit 603 includes the data stored in the register 19 in the Java application data, even when the Java application 601 does not include the data stored in the register 19 in the Java application data is described.

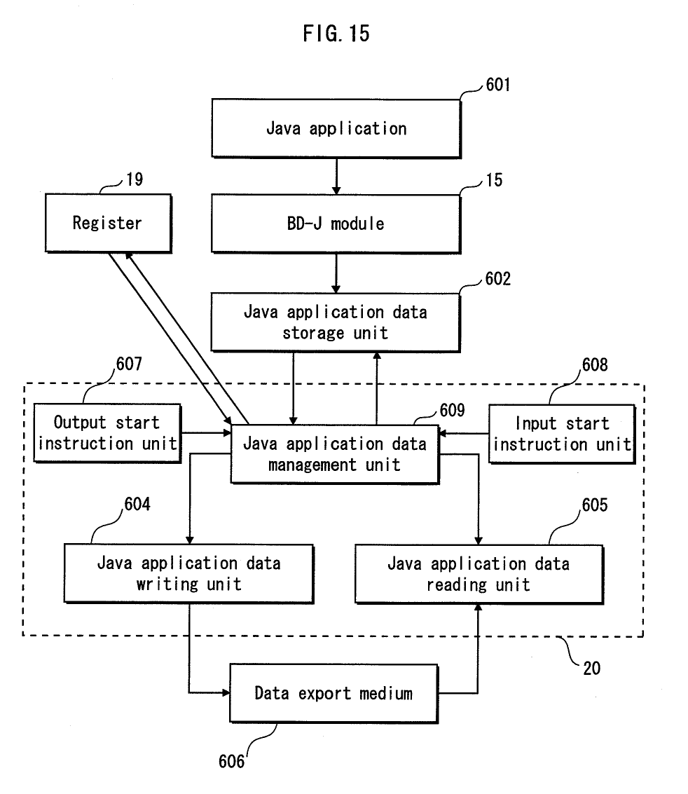

FIG. 15 shows a mechanism to share the Java application data among playback devices in embodiment 2. To the same components as those shown in FIG. 5 and FIG. 6, the same numbers are assigned, and description thereof is omitted.

In addition to a function of the Java application data management unit 603, a Java application data management unit 609 has functions to transmit the Java application data stored in the Java application data storage unit 602 to the Java application data writing unit 604, and also transmit the data stored in the register 19 to the Java application data writing unit 604. Also, upon reading out the Java application data from the Java application data reading unit 605, the Java application data management unit 609 writes the read out data to the Java application data storage unit 602, and also, when the read out Java application data includes data which has to be written to the register 19, writes the data to the register 19.

The Java application data management unit 609 judges whether or not the read out data includes the data which has to be written to the register 19 in an arbitrary manner. For example, when the Java application data is transmitted to the Java application data writing unit 604, for each element included in the Java application data, information showing that the element should be stored in the Java application data storage unit 602 or the element should be stored in the register 19 may be added. Then, the information is stored in the data export medium 606 along with the Java application data, and the Java application data is acquired along with the added information from the Java application reading unit 605. Similarly, the Java application data may be stored in the data export medium 606 so as to have a data structure by which each element is classified by a storage location such as the Java application data storage unit 602 and the register 19.

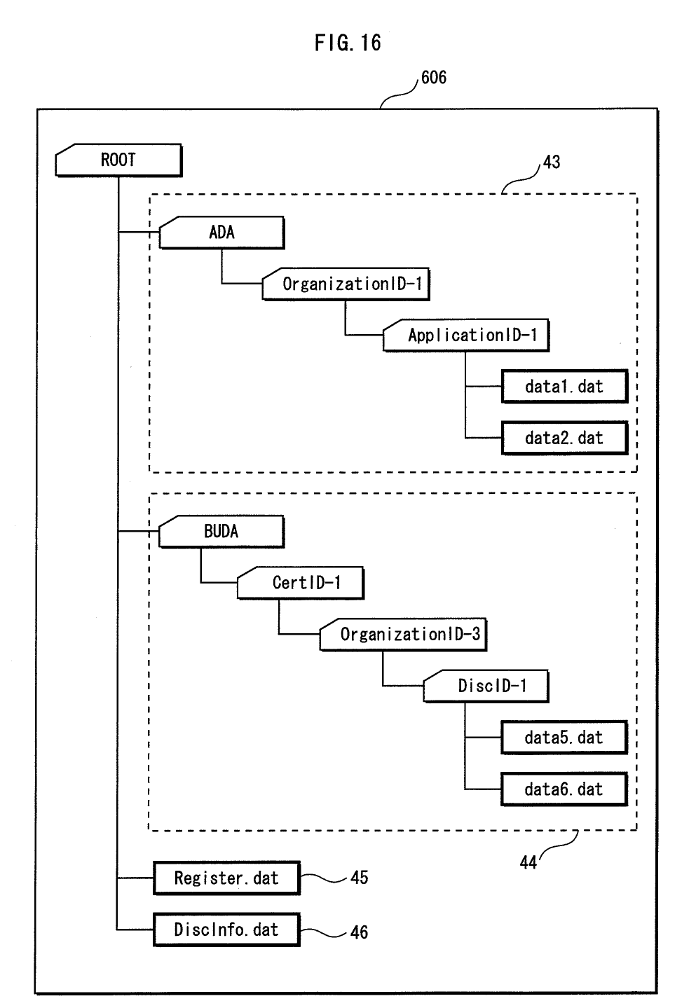

FIG. 16 diagrammatically shows an example of the data export medium 606. To the same components as those shown in FIG. 10, the same numbers are assigned, and description thereof is omitted.

In FIG. 16, a file structure stored in the data export medium 606 includes the group of files 43, the group of files 44, register information 45, and content information 46.

The register information 45 shows an example in which data stored in the register 19 is stored in the data export medium 606. In FIG. 16, the data is stored as “Register.dat”.

The content information 46 shows an example in which a content identifier for identifying a content corresponding to data stored in the register 19 is stored in the data export medium 606. In FIG. 16, an identifier of a BD-ROM disc inserted in the BD-ROM drive 1 is stored as “DiscInfo.dat”.

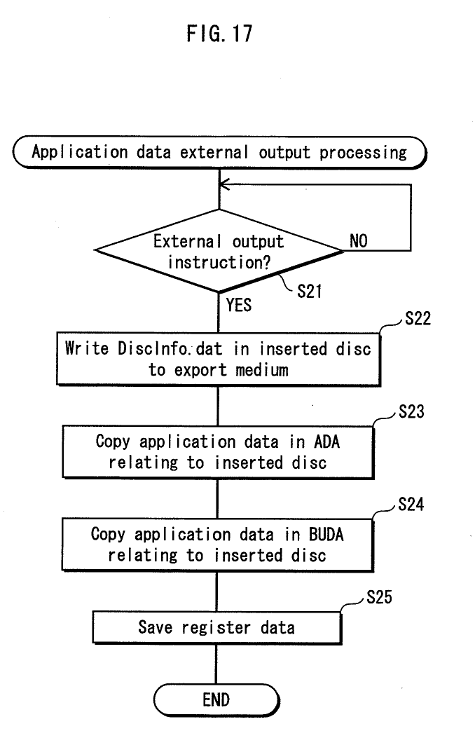

The following describes steps of application data external output processing in this embodiment, with use of FIG. 17. The processing shown in the drawing includes, in addition to processing shown in FIG. 13, processing in which the identifier of the BD-ROM disc inserted in the BD-ROM drive 1 is stored in the data export medium 606 as a DiscInfo.dat (step S22), and processing in which data stored in the register 19 is stored in the data export medium 606 as a Register.dat (step S25). The above is the steps of the application data external output processing in this embodiment.

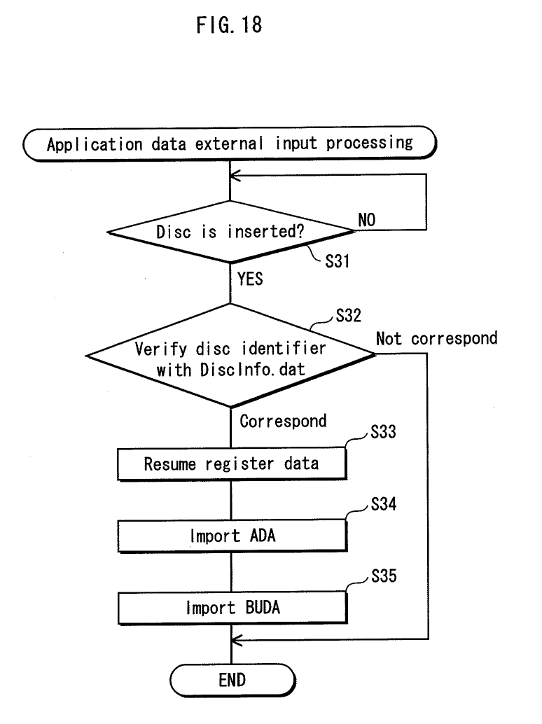

The following describes steps of application data external input processing in this embodiment, with use of FIG. 18. The processing shown in the drawing includes, in addition to processing shown in FIG. 14, processing in which whether the identifier of the BD-ROM disc inserted in the BD-ROM drive 1 and the data stored as DiscInfo.dat correspond with each other is verified (step S32), and processing in which the data stored as the Register.dat is restored in the register 19 (step S33). The latter is performed when the identifier of the inserted disc and the data stored as DiscInfo.dat correspond with each other in step S32 (step S32: Yes). The above is the steps of the application data external input processing in this embodiment.

As described above, in this embodiment, the data stored in the register 19 can be shared among playback devices. This enables resume processing to be inherited by another playback device capable of performing the resume processing by using the data stored in the register 19. Specifically, when a content which has been played back halfway is stopped being played back in a playback device, and the content is inserted in another playback device, the content can be continuously played back from a position at which playback has been stopped, even though the playback devices differ from each other.

### Embodiment 3

In embodiment 1 and embodiment 2, a case where the Java application data is once stored in the data export medium 606 is described. Yet in this embodiment, a method to realize sharing of the Java application data among a plurality of playback devices without involving the data export medium 606 is described.

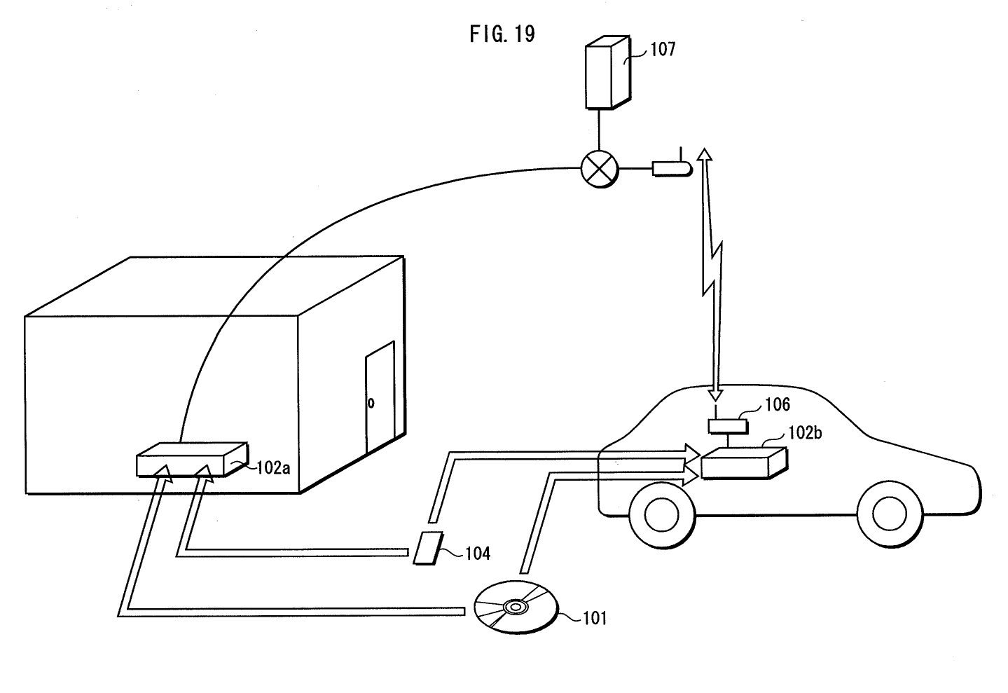

FIG. 19 shows a use case of a playback device in embodiment 3. As shown in the drawing, a playback device 102a placed in a home and an in-car playback device 102b are connected by a network, and can transmit/receive data with each other.

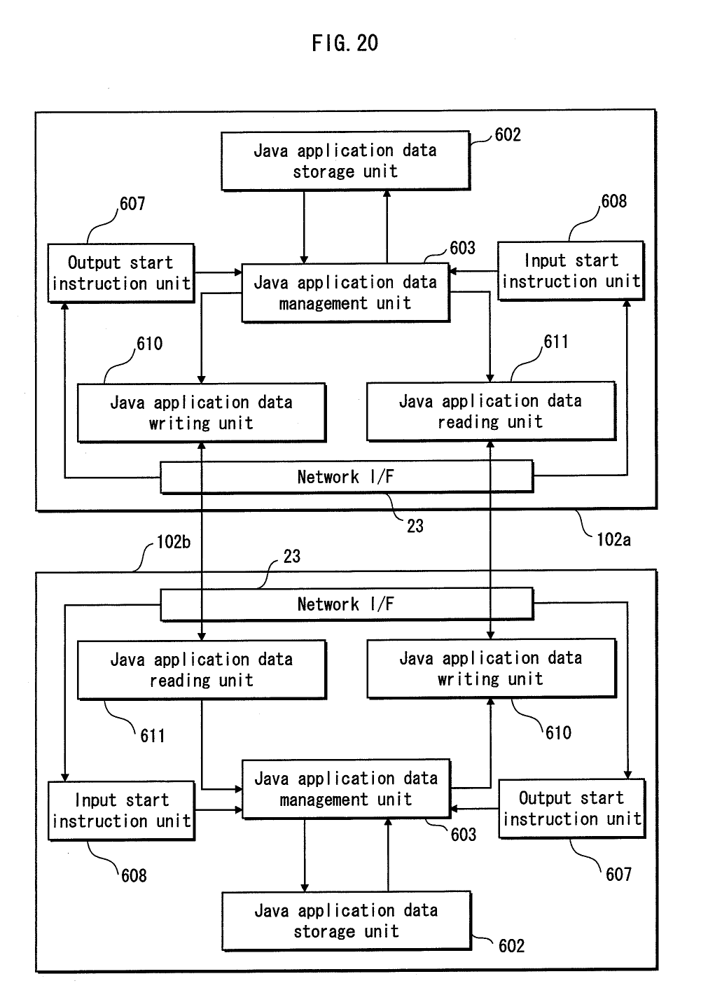

A structure with which application data is shared between the playback device 102a and the in-car playback device 102b is shown in FIG. 20. To the same components as those in FIG. 4 and FIG. 6, the same numbers are assigned, and description thereof is omitted.

The playback device 102a and the in-car playback device 102b are directly or indirectly connected via a network interface 23. Note that the playback device 102a and the playback device 102b do not have to be connected at all times. The present invention can be realized as long as they are connected when an effect described in this embodiment is required.

In embodiment 1, the Java application writing unit 604 is described to store the Java application data having been transmitted from the Java application data management unit 603 in the data export medium 606. However, the Java application data writing unit 610 in this embodiment is characterized by transmitting the Java application data having been transmitted from the Java application data management unit 603 to another playback device via the network interface 23. The Java application data writing unit 610 differs from the Java application data writing unit 604 only in that it transmits the data to the other playback device instead of storing the data in the data export medium 606.

In embodiment 1, the Java application reading unit 605 is described to read out the Java application data from the data export medium 606. However, the Java application data reading unit 611 in this embodiment is characterized by reading out the Java application data input from the outside of the playback device via the network interface 23. The Java application data reading unit 611 differs from the Java application data reading unit 605 only in that it reads out the data input from the outside of the playback device instead of reading out the data from the data export medium 606.

The following describes an example in which the Java application data is transferred from the playback device 102a to the playback device 102b. Suppose that the playback device 102a is playing back a content, and a Java application which is executed to play back the content stores the Java application data in the Java application data storage unit 602.

First, operation of the playback device 102a is described. The playback device 102b is connected to the playback device 102a via the network interface 23. In the playback device 102a, upon detecting the connection of the playback device 102b, the network interface 23 instructs the output start instruction unit 607 to transmit a Java application data output instruction to the Java application data management unit 603. Upon receiving the instruction from the network interface 23, the output start instruction unit 607 transmits the Java application data output instruction to the Java application data management unit 603. Upon receiving the Java application data output instruction from the output start instruction unit 607, the Java application management unit 603 reads out a part or all of the Java application data stored in the Java application data storage unit 602, and transmits the readout Java application data to the Java application writing unit 610. Upon receiving the Java application data transmitted from the Java application data management unit 603, the Java application writing unit 610 outputs the received Java application data to the network interface 23.

The, operation of the playback device 102b is described. The playback device 102a is connected to the playback device 102b via the network interface 23. In the playback device 102b, upon detecting the connection of the playback device 102a, the network interface 23 instructs the input start instruction unit 608 to transmit a Java application data input instruction to the Java application data management unit 603. Upon receiving the instruction from the network interface 23, the input start instruction unit 608 transmits the Java application data input instruction to the Java application data management unit 603. Upon receiving the Java application data input instruction from the input start instruction unit 608, the Java application management unit 603 instructs the Java application data reading unit 611 to read out the Java application data. The Java application reading unit 611 reads out the Java application data instructed by the Java application data management unit 603, and transmits the read out data to the Java application management unit 603. Here, the data read out from the network interface 23 is the data output from the playback device 102a. Upon receiving the Java application data from the Java application data reading unit 611, the Java application management unit 603 writes the received data to the Java application data storage unit 602.

When a plurality of playback devices are connected with each other, a playback device to/from which the Java application data is transmitted can be determined in an arbitrary manner. For example, it is possible that a user selects whether the Java application data is transmitted or received, and, by comparing data stored in the Java application data storage unit 602 included in each playback device, a playback device storing newer data transmits the Java application data and the other playback device receives the transmitted data.

When comparing data stored in the Java application data storage unit 602 included in each playback device, the data can be compared without transmitting/receiving the Java application data itself by transmitting/receiving only, for example, a file name, update date and time, a file size, as management information of the Java application data.

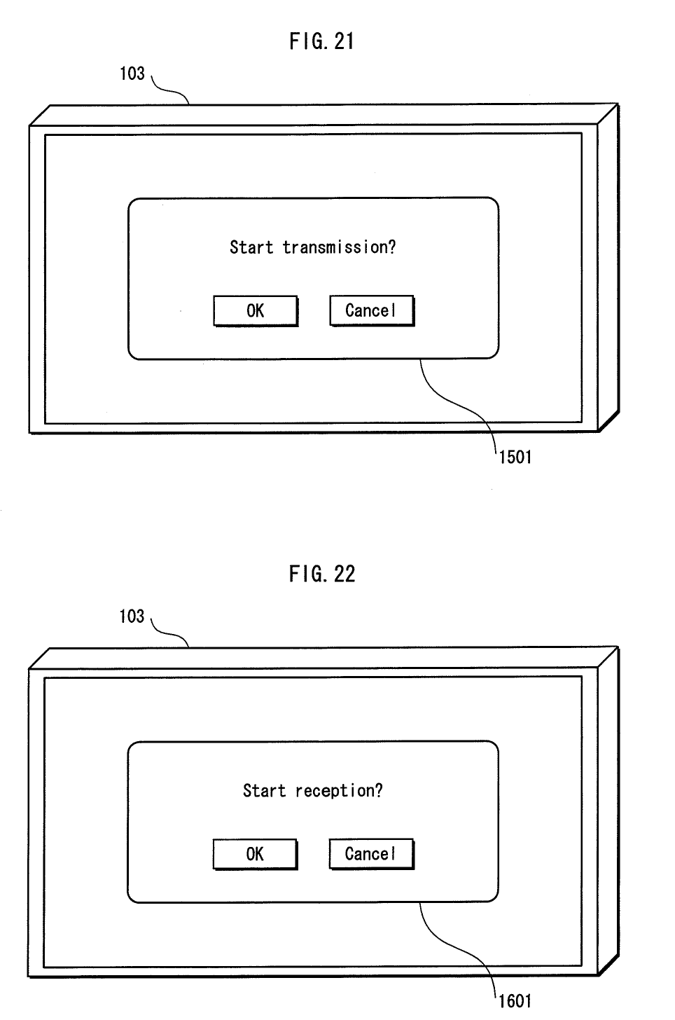

Also, when the playback device 102a and the playback device 102b are connected with each other, in the playback device 102a, the output start instruction unit 607 is described to transmit the Java application data output instruction to the Java application data management unit 603 upon receiving an instruction from the network interface 23. However, arbitrary processing can be added from the time the output start instruction unit 607 receives the instruction from the network interface 23 until the time the output start instruction unit 607 transmits the Java application data output instruction to the Java application data management unit 603. For example, it is possible to inform, by displaying a selection screen 1501 on the TV 103 as shown in FIG. 21, a user that the Java application data is to be transmitted, and to inquire whether or not the transmission is allowed. When the user refuses to transmit the Java application data to the playback device 102b, it is possible not to transmit the Java application data output instruction to the Java application data management unit 603. Also, information about the playback device 102b and the Java application data to be transmitted may be added on the selection screen 1501. Similarly, in the playback device 102b, the input start instruction unit 608 is described to transmit the Java application data input instruction to the Java application data management unit 603 upon receiving an instruction from the network interface 23. However, arbitrary processing can be added from the time the input start instruction unit 608 receives the instruction from the network interface 23 until the time the input start instruction unit 607 transmits the Java application data input instruction to the Java application data management unit 603. For example, it is possible to inform, by displaying a selection screen 1601 on the TV 103 as shown in FIG. 22, a user that the Java application data is to be received, and to inquire whether or not the reception is allowed. When the user refuses to receive the Java application data from the playback device 102a, it is possible not to transmit the Java application data input instruction to the Java application data management unit 603. Also, information about the playback device 102a may be added on the selection screen 1601.

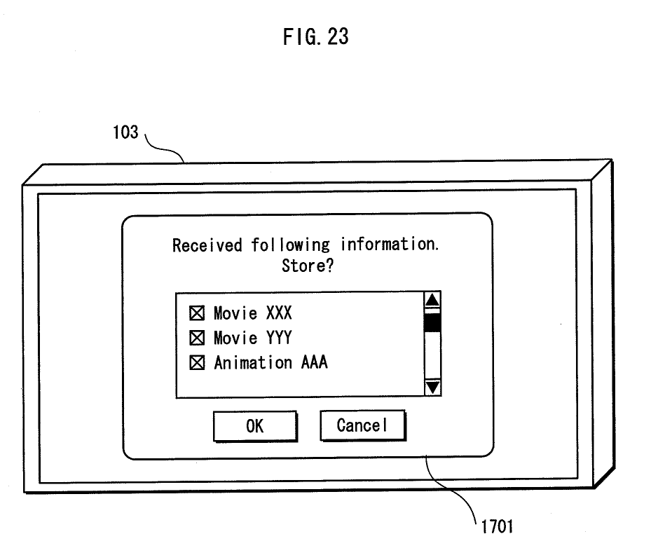

Further also, in the playback device 102b, the Java application data management unit 603 is described to write the Java application data to the Java application data storage unit 602 upon receiving the Java application data from the Java application data reading unit 611. However, before writing the data to the Java application data storage unit 602, information about the Java application data to be written may be shown to a user by displaying a selection screen 1701 on the TV 103 as shown in FIG. 23. When the user does not allow the Java application data to be written, it is possible that the Java application data management unit 603 does not write the Java application data. Also, a list of the Java application data to be written may be displayed on the selection screen 1701, a user selects the Java application data which is allowed to be written, and only the selected Java application data may be written to the Java application data storage unit 602.

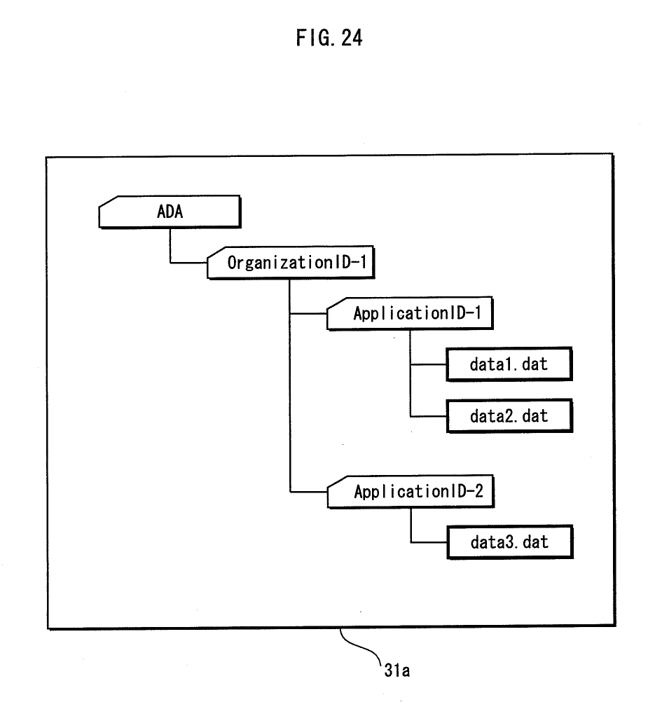

Another example is described as follows. When the playback device 102a and the playback device 102b are connected with each other, by comparing the data stored in the Java application data storage unit 602 included in the playback device 102a and the playback device 102b, a Java application data can be shared. For example, suppose that the data stored in the Java application storage unit 602 included in the playback device 102a has a file structure shown in FIG. 8. On the other hand, suppose that the data stored in the Java application storage unit 602 included in the playback device 102b has a file structure shown in FIG. 24.

The file structure shown in FIG. 24 is a part of the file structure shown in FIG. 8. Specifically, compared with the file structure shown in FIG. 8, the file structure shown in FIG. 24 does not include the “data4.dat”, which is data stored by a Java application having identifiers named “Organization ID-2” and “Application ID-3”. When the playback device 102a and the playback device 102b are connected with each other in such condition, the Java application data management unit 603 included in each playback device detects that the “data4.dat”, which is the data stored by the Java application having identifiers named “Organization ID-2” and “Application ID-3”, is not included. Then, in order to synchronize the data stored in each Java application data storage unit 602, the playback device 102a outputs the “data4.dat” as a Java application data, and the playback device 102b stores the “data4.dat” output from the playback device 102a as a Java application data in the Java application data storage unit 602. As a result, the Java application data storage unit 602 included in the playback device 102b comes to store the same data as that stored in the Java application data storage unit 602 included in the playback device 102a. Therefore, when the playback device 102b plays back a content which has been played back by the playback device 102a and includes a Java application having stored therein the “data4.dat”, the Java application can use the “data4.dat”, which has been stored in the playback device 102a, in the playback device 102b as well.

As mentioned above, in this embodiment, Java application data can be shared among playback devices without using a data export medium.

Note that the present invention can be realized by the other method as long as a part or all of the data stored in Java application data storage unit 602 included in each of a plurality of playback devices can correspond with each other by using a function to output such data from a playback device or to input such data from the outside of the playback device.

### Embodiment 4

In embodiment 1, 2 and 3, a case where data stored in the Java application data storage unit 602 included in a playback device is copied to the Java application data storage unit 602 included in another playback device by using any method is described. However, in this embodiment, a mechanism by which the Java application data is shared without being copied to the Java application storage unit 602 included in the other playback device.

A playback device in this embodiment is characterized by, when a recording medium which can be used as the data export medium 606 is connected thereto, using the recording medium as a recording medium to/from which the Java application is written/read instead of the Java application data storage unit 602.

When an executing Java application requests for reading or writing of the Java application data, the BD-J module 15 normally performs reading or writing processing of data having been stored/to be stored in the Java application data storage unit 602. However, when the data export medium 606 is connected thereto, the BD-J module 15 performs reading or writing processing of data having been stored/to be stored in the data export medium 606.

Also, as shown in embodiment 3, when playback devices are directly or indirectly connected with each other, upon receiving a request for reading of the Java application data from the executing Java application, the BD-J module 15 requests the input start instruction unit 608 for input of a file specified by the Java application, and transmits the Java application data received by the Java application data management unit 603 to the Java application which has requested for the data so that data stored in the Java application data storage unit 602 included in the other playback device can be transmitted to the executing Java application. Also, upon receiving a request for writing of the Java application data from the executing Java application, the BD-J module 15 requests the output start instruction unit 607 for output of a file specified by the Java application, and transmits the data which has been requested to be output by the Java application to the Java application data management unit 603 so that data specified by the executing Java application can be stored in the Java application data storage unit 602 included in the other playback device.

Also, in a use case shown in FIG. 19, an external recording device 107, which is connected via a network, can be used as the Java application data storage unit 602 or the data export medium 606.

Note that whether or not a connected data export medium 606 is used as the Java application data storage unit 602 may be determined in an arbitrary manner. For example, when the data export medium 606 is connected thereto, whether or not it is used as the Java application data storage unit 602 may be confirmed by a user. Alternatively, when the data export medium 606 has been preliminarily permitted to be used as the Java application data storage unit 602, the connected data export medium 606 may be used as the Java application data storage unit 602 without being confirming by a user as long as uniqueness of the data export medium 606 is confirmed by a publicly known technology.

In this embodiment, the Java application data can be shared without copying it to another playback device.

[Modifications]

The present invention has been explained in accordance with the above embodiments, however it is obvious that the present invention is not limited to the above embodiments. The following modifications are also included in the present invention.

(1) The present invention may be a playback device control method disclosed in processing steps of each flow chart described in the above embodiments. The present invention may be a computer program including a program code capable of causing a computer to operate by the above-mentioned processing steps, or a digital signal composed of the computer program.

Also, the present invention may be computer-readable recording medium like flexible disk, hard disc, CD-ROM, MO, DVD, DVD-ROM, DVD-RAM, BD (Blu-ray Disc), and semiconductor memory, recorded with the above-mentioned computer program or digital signal.

Also, the present invention may be implemented by transmitting the above-mentioned computer program or digital signal via a network represented by an electric communication line, a wireless or a wired communication line, and the internet.

Also, other independent computer system may implement the present invention by transferring the recording medium recorded with the above-mentioned computer program or digital signal, or by transferring the above-mentioned computer program or digital signal via the network and the like.

(2) The present invention may be implemented as LSI operable to control a data management device described in the above embodiments. Such LSI can be realized by integrating functional blocks realized by the control unit 13 shown in FIG. 5. Such functional blocks may be achieved on one chip, or part or all thereof may be achieved on one chip.

Although a LSI is taken for an example here, it may be called as IC, system LSI, super LSI, and ultra LSI, depending on a difference in integration degree.

Also, the integrated circuit is not limited to the LSI, and it may be realized by a dedicated communication circuit or a universal processor. It may be realized by FPGA (Field Programmable Gate Array) operable to program after a LSI being produced, or a reconfigurable processor operable to reconfigure a connection or a setup of a circuit cell inside of a LSI.

And further, if a technology of an integrated circuit replacing a LSI comes out by a progress of a semiconductor technology or other derivative technology thereof, naturally the technology may be used for integration of functional blocks and members. Biotechnology and the like may be applied to this kind of technology.

(3) The embodiments and the modification may be combined with each other.

### INDUSTRIAL APPLICABILITY

The playback device constructing the present invention can be commercially, continuously, and repeatedly manufactured and sold in a manufacturing industry, and especially can be used in a movie industry and a commercial device industry involving production of a video content.

### REFERENCE SIGNS LIST

1 BD-ROM drive
2 Track buffer
3 Demultiplexer
4 Video decoder
5 Video plane
6 Audio decoder
7 Image memory
8 Image decoder
9 Image plane
10 Composition unit
11 Static scenario memory
12 Dynamic scenario memory
13 Control unit
14 HDMV module
15 BD-J module
16 Mode management module
17 Dispatcher
18 AV playback library
19 Register
20 Application data input/output control unit
21 UO detection module
22 Rendering engine
23 Network interface
24 Local storage
25 Virtual file system
26 Nonvolatile memory
31 ADA directory
32 BUDA directory
41 Group of files
42 Group of files
43 Group of files
44 Group of files
45 Register information
46 Content information
101 BD-ROM
102 Playback device
102a Playback device
102b Playback device
103 TV
104 Removable medium
105 Remote control
107 External device
601 Application
602 Application data storage unit
603 Application data management unit
604 Java application data writing unit
605 Java application data reading unit
606 Data export medium
607 Output start instruction unit
608 Input start instruction unit
609 Application data management unit
610 Java application data writing unit
611 Java application data reading unit
701 Selection screen
801 Message
1501 Selection screen
1601 Selection screen
1701 Selection screen

1. A playback device that plays back a digital stream having been stored in a read-only recording medium and executes an application program, the playback device comprising:
an internal recording medium that has a recording area from/into which the application program is permitted to read/store information, the recording area being identified by an identifier held by the read-only recording medium, and
an external output unit operable to output, to the outside of the playback device, information stored by executing the application program in the recording area from/into which the application program is permitted to read/store information.

2. The playback device of claim 1, wherein
the output performed by the external output unit is realized by writing the information to an external recording medium.

3. The playback device of claim 2, wherein
the external recording medium is a readable/writable portable recording medium.

4. The playback device of claim 3, wherein
the external recording medium is an external storage connected to the playback device via a network.

5. A playback device that plays back a digital stream having been stored in a read-only recording medium and executes an application program, the playback device comprising:
an internal recording medium that has a recording area from/into which the application program is permitted to read/store information, the recording area being identified by an identifier held by the read-only recording medium, and
an external input unit operable to acquire, from the outside of the playback device, information which can be used when the application program is executed, and store the acquired information in the recording area from/into which the application program is permitted to read/store information.

6. The playback device of claim 5, wherein
the acquisition performed by the external input unit is realized by reading the information from an external recording medium.

7. The playback device of claim 6, wherein
the external recording medium is a readable/writable portable recording medium.

8. The playback device of claim 6, wherein
the external recording medium is an external storage connected to the playback device via a network.

9. A playback device that plays back a digital stream having been stored in a read-only recording medium and executes an application program, the playback device comprising:
an internal recording medium that has a recording area from/into which the application program is permitted to read/store information, the recording area being identified by an identifier held by the read-only recording medium,
an external output unit operable to output, to the outside of the playback device, information stored by executing the application program in the recording area from/into which the application program is permitted to read/store information, and
an external input unit operable to acquire, from the outside of the playback device, information which can be used when the application program is executed, and store the acquired information in the recording area from/into which the application program is permitted to read/store information.

10. A playback system including a plurality of playback devices that play back a digital stream having been stored in a read-only recording medium and execute an application program, the playback system comprising:
a first playback device comprising:
a first internal recording medium that has a first recording area from/into which the application program is permitted to read/store information, the first recording area being identified by an identifier held by the read-only recording medium, and
an external output unit operable to output, to the outside of the first playback device, information stored by executing the application program in the first recording area, and
a second playback device comprising:
a second internal recording medium that has a second recording area from/into which the application program is permitted to read/store information, the second recording area being identified by the identifier held by the read-only recording medium, and
an external input unit operable to acquire the information output from the external output unit, and store the acquired information in the second recording area.

11. The playback system of claim 10, wherein
when playback of the digital stream having been stored in the read-only recording medium is stopped in the first playback device, the external output unit further outputs playback information regarding a position at which the playback is stopped,
the external input unit further acquires the playback information output from the external output unit, and
the second playback device starts playback of the digital stream having been stored in the read-only recording medium from the position at which the playback is stopped in the first playback device in accordance with the acquired playback information.

12. The playback system of claim 10, wherein
the first playback device and the second playback device are directly connected with each other, and
the information is transferred from the external output unit to the external input unit.

13. A control method of a playback device that plays back a digital stream having been stored in a read-only recording medium and executes an application program, the control method comprising the steps of:
outputting, to the outside of the playback device, information stored by executing the application program in a recording area included in an internal medium of the playback device from/into which the application program is permitted to read/store information, and
the recording area from/into which the application program is permitted to read/store information is identified by an identifier held by the read-only recording medium.

14. A control method of a playback device that plays back a digital stream having been stored in a read-only recording medium and executes an application program, the control method comprising the steps of:
acquiring, from the outside of the playback device, information which can be used when the application program is executed, and storing the acquired information in a recording area included in an internal medium of the playback device from/into which the application program is permitted to read/store information, and
the recording area from/into which the application program is permitted to read/store information is identified by an identifier held by the read-only recording medium.
